(19) United States
(12) Patent Application Publication
(10) Pub. No.: US 2002/0091777 A1
(43) Pub. Date: Jul. 11, 2002

(54) Method and system for automatically generating a message reply and file

(76) Inventor: Lisa Miller Schwartz, West Bloomfield, MI (US)

Correspondence Address: Paul M. Schwartz, Schwartz & Schwartz, P.L.C., Suite 200, 29623 Northwestern Highway, Southfield, MI, 48034, US

(21) Appl. No.: 10/014,097

(22) Filed: Dec. 11, 2001

Related U.S. Application Data
(63) Continuation-in-part of application No. 09/602,900, filed on Jun. 23, 2000.

(51) Int. Cl. G06F 15/16

(52) U.S. Cl. 709/206

(57) ABSTRACT

A method and system for automatically generating a message reply and file. The method and system are adapted for use with a communications system including at least one message server operative to receive and store messages or files for retrieval. Each message/file has a sender address and a recipient address. A reply message is stored and automatically forwarded to a sender along with a file upon receipt of a message/file having a selected recipient address and at least one sender address. A reply file may also be stored and automatically forwarded to the sender.

### TECHNICAL FIELD

Method and system for automatically generating a message reply and file.

### BACKGROUND ART

Electronic mail or “e-mail” as it has become known in the art, has become increasingly popular over the last several years. The most obvious reason is the proliferation of e-mail networks which have been brought to the masses by internet portals such as, for example, America Online, Microsoft, Yahoo, Earthlink, etc. As those skilled in the art will recognize, e-mail networks permit a network of communicating users to transmit information such as, for example, text, graphics, facsimile, voice, video, etc. from one user to another. Each user has a unique address or “mailbox” which corresponds to a logical and/or physical location (typically a server) where the user may receive and retrieve his or her “mail”.

Typically, an electronic message, whether it is a text based e-mail, a facsimile image, a video, or a voice message, is generated by a user at a computer or other suitable wired or wireless electronic device such as, for example, a personal digital assistant, a telephone, a charge coupled device (CCD),or a facsimile machine. The message includes a sender address and at least one recipient address. Typically, the sender address is automatically attached to the message or is included in a message header at the time the message is generated or sent. The recipient address must be indicated by the sender by typing or other suitable manner such as selection from a user address book. Those skilled in the art are familiar with the above addressing schemes and, therefore, they need not be discussed in further detail.

The computer or electronic device is provided in communication with one or more suitable message servers. The server is operative to receive the generated message and associate the designated recipient address with a specific recipient. For example, in the case of electronic mail, an e-mail message will typically be generated at a computer and sent over a network such as, for example, the Internet or an intranet for receipt by an e-mail server. On receipt of the e-mail message, the server will associate the addressed message with a specific recipient and store the message in a mailbox for retrieval by the recipient at a later date. As indicated above, the mailbox may be a physical and/or logical location.

Again, as those skilled in the art will recognize, fax messages and voice mail messages work in much the same manner with the exception that the associated server is generally but not necessarily, a dedicated fax server or voice mail server. The associated network may, of course, be any suitable network including any wired or wireless network including without limitation the Internet, an intranet, a broadband network, a narrowband network, a fiber optic network, a radio network, or any combination thereof.

Message service users, and in particular, electronic mail users, have learned that checking for their e-mail messages is a relatively time-consuming process which generally requires the user to first log on to his or her associated network. Thereafter, the user may generate a suitable query to the associated server. Typically, this is accomplished transparently to the user by selecting or “clicking” on an associated mailbox icon. The server performs a database look up to determine if any messages have been stored for the recipient. The server thereafter indicates the state of the user's mailbox (e.g. no new messages, 5 new messages, etc.) to the user. Typically, this information is provided in a list format. The user may also be advised of other information such as the sender, the title, date sent, etc.

If a user desires to retrieve a message, she typically selects the identified message by “clicking” on it or other suitable manner. This action generates a request (transparent to the user) to the server to forward the selected message over the network to the user for display on the user's computer or other electronic device. Again, the manner in which this information is identified, selected, and provided to a user is well known in the art.

Attempts have been made in the art to automatically notify recipients of the presence of e-mail at their associated server without requiring the user to log on to their network. See, for example, U.S. Pat. No. 5,944,786 issued to Ken Quinn. See also, the Compaq Internet PC which provides an LCD display at the user's computer tower that e-mail messages have been received for one or more users.

While the above efforts have lessened user frustration on the recipient side, they have neither recognized nor addressed the problems faced by senders, the most notorious of which is confirming that a sent message has, in fact, been received. As those skilled in the art will recognize, conventional e-mail systems, facsimile systems, etc. confirm only that a message has been sent, not whether it has been received. A typical e-mail user may send and receive dozens of electronic messages each day. If an e-mail recipient is out of her office or, for whatever reason, unable or unwilling to access her network, messages sent by others will accumulate in her associated mailbox. As readily seen, extended time periods of this type such as, for example, vacations, weekends, etc., may result in numerous messages being accumulated for which the recipient has neither received nor replied to.

Consequently, a need has developed for an automated method and system for generating a reply to an electronic message. Such a system should be adapted for use in a suitable network such as the Internet, intranet, or any broadband, narrowband, fiber optic network, radio network, or any combination thereof and should allow an electronic message recipient to automatically generate one or more replies to senders. Such a method should further be adapted to permit forwarding of a selected file along with the generated reply. Such an automated reply file should be capable of being attached directly to a reply message or sent separately.

### DISCLOSURE OF INVENTION

It is the principle object of the present invention to provide a method and system for automatically generating a message reply and file.

It is the further object of the present invention to provide such a method and system wherein one or more reply messages and files may be forwarded for receipt by selected senders in accordance with suitable predetermined criteria such as, for example, date, time, day of week, number of e-mail messages sent to the recipient, number of e-mail messages sent to the recipient by a specific sender, the date the recipient last retrieved e-mail, the time the recipient last retrieved e-mail, the date the recipient last received e-mail from a specific sender, or the date the recipient last sent e-mail to a specific sender.

In carrying out the above objects, there is provided an automated method for a recipient to reply to an electronic message. The method is specifically adapted for use with a communication system such as, for example, the Internet, an intranet, or any suitable coaxial cable network, fiber optic network, broadband network, narrowband network, radio network, or any combination thereof which includes at least one message server which is operative to receive and store messages for retrieval by a recipient. In keeping with the invention, the message server may be an e-mail server, a fax server, or a voice mail server, or any other suitable electronic message server. Messages should have at least a sender address and a recipient address. A reply message which is typically, but not necessarily, generated by the recipient is stored and associated with the recipient's address and one or more selected sender addresses. A reply file is similarly stored and associated with a reply message and/or the recipients address and one or more selected sender addresses. On receipt of a message bearing the recipient's address, the reply message is automatically forwarded to the sender along with the reply file.

In a preferred embodiment, reply messages and reply files are stored at an associated message server or a database or other peripheral in communication therewith. The recipient may generate or have generated for her a standard reply message and reply file to be sent to all electronic message senders, may select from one or more standard reply messages and files, or may generate sender-specific reply messages and files, any of which may be provisioned in the associated network or electronic message server to be sent based on predetermined criteria such as, for example, the date, time, day of week, number of e-mail messages sent to the recipient, number of messages sent to the recipient by the sender, the date the recipient has last retrieved messages, the date the recipient has last received a message from the sender, the date the recipient has last sent a message to the sender, or any other suitable criteria which can be provisioned within the system.

In carrying out the above method, there is provided a messaging system which comprises at least one message server in communication with a plurality of computers or suitable customer premises equipment (CPE) each of which is operative to send and receive electronic messages via at least one message server. Each electronic message has a sender address and a recipient address. In keeping with the invention, the message server which is typically, but not necessarily, an e-mail server, a fax server, or a voice mail server, is operative to store a reply message from the recipient for a message sent having the recipient's address and a selected sender address. The message server is further operative to store a reply file to be sent along with the reply message. Still further, the message server is operative to automatically forward the reply message and reply file to the sender address. In a preferred embodiment, the reply file is sent as an attachment to the reply message. However, the attachment may, of course, be sent separately. As indicated above, the recipient may select from one or more standard reply messages and/or reply files or may generate sender-specific reply messages or files based on predetermined criteria. In keeping with the invention, the reply files may comprise any suitable file including, without limitation, a text file (e.g. Microsoft Word, Corel Wordperfect, etc.), a still image (e.g. JPEG, GIF, TIFF, PICT, EPS, PDF, PNG, DCF, DPOF, FLASHPIX, etc.) an audio clip (e.g. MPEG, MPEG II, MPEG III, MPEG IV etc.), a video clip, an Internet link, etc.

These and other objects, features, and advantages of the present invention will become more readily apparent with reference to the following diagrams wherein like reference numbers correspond to like components.

### BRIEF DESCRIPTION OF DRAWINGS

FIG. 1 is a schematic diagram of the system of the present invention.

FIG. 2 is a block diagram of the method steps of the present invention.

### BEST MODE FOR CARRYING OUT THE INVENTION

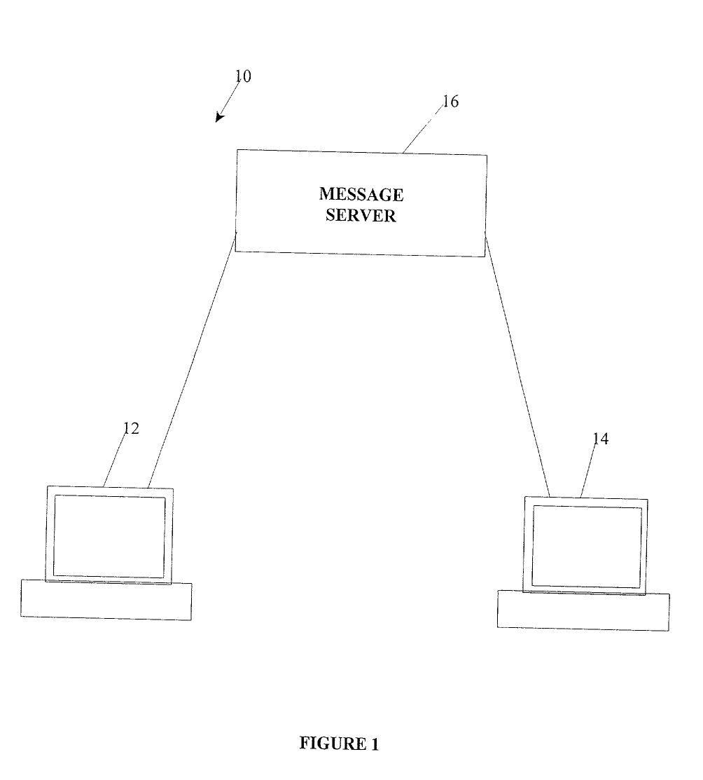

With reference to FIG. 1 of the drawings, there is shown a communication network designated generally by reference 10 which includes a sending electronic device such as a computer 12, a receiving electronic device such as a computer 14, and at least one message server 16 all provided in communication with one another via a suitable interface and data transfer means. The term “message” is used herein in its broadest sense and is understood to encompass any electronic signal including, without limitation, electronic files. Network 10 may comprise, for example, the Internet, an intranet, or any other suitable wired or wireless communication system including, without limitation, a broadband network, a narrowband network, a fiber optic network, a radio network, a coaxial cable network, or any combination thereof. Message server 16 may comprise an e-mail server, a fax server, a voice mail server, or any other suitable message server having the appropriate provisioning to store sender addresses, recipient addresses, and predetermined reply messages in an associated look-up table or database and the required functionality to match and forward such messages to recipients on request.

As indicated above, sending and receiving devices 12 and 14, respectively, may be any electronic device capable of generating and/or receiving and displaying messages such as, for example, a desktop computer, a notebook computer, a personal digital assistant, a telephone, a charge coupled device such as a wired or wireless digital camera, a facsimile machine, a printer, etc.

In keeping with the invention, each user has an associated profile provisioned in the server 16. The profile includes the subscriber's address, i.e. “mailbox” or other suitable account number, one or more reply messages to be generated in response to messages/files from one or more or all senders and the corresponding addresses (if less than all) of the senders. Of course, where the reply is based on criteria independent of the subscriber, such as, for example, time, the sender addresses need not be stored. This information is stored in a suitable look up table or database within the server or provisioned in communication with the server. A user may select from any number of standard replies such as, for example, the following: “the recipient of your message has left the office for the day and will not retrieve or respond to your message until tomorrow”. Alternatively, a reply may be selected for weekends which might indicate the following: “the recipient of your message has left the office for the weekend and will not retrieve or respond your to message until the next business day”. Still further, a user may select a reply to be generated when the user is on vacation which may indicate the following: “the recipient of your message is on vacation until <DATE> and will not retrieve or respond to your message until this date.

In keeping with the invention, the stored replies may be text, audio, graphics, video, facsimile image, or any combination thereof, or other suitable information type. Still further, replies may be generated in response to received e-mail messages, voice messages, fax messages, video messages, image files, data files, audio files, etc. Of course, where a medium is selected for an automated reply which is different from the medium of the message, the system must be provisioned accordingly to perform the required database look up. For example, an e-mail reply may be generated in response to a voice mail message. However, the sender's e-mail address must be provisioned within the server (by the sender or the recipient) and cross-referenced by a database look up with the sender's voice mail address. If provisioned by the recipient, the recipient would need to identify in advance, alternative addresses for selected senders. For example, a recipient would be required to identify as input to the server a selected sender's voice mail and fax address for later cross-referencing if the recipient's reply message profile designates a reply to an e-mail message to be generated and sent under certain circumstances to the sender's voice mail and/or fax address. In keeping with the invention, multiple automated replies may, of course, be sent to the same sender at different addresses and different mediums.

Alternatively, in a preferred embodiment, the voice mail message or any message/file for that matter, may itself include alternative sender addresses for disparate media. For example, a voice mail message may include as an attachment or as part of a header, the sender's e-mail and fax addresses. Similarly, an e-mail message my include as an attachment or as part of a header, the sender's voice mail and facsimile addresses. Still further, an image file may include the sender's digital camera address (e.g. IP address, radio address, calling number etc.) as well as the sender's e-mail address and/or imaging service account number where the user desires to receive an automated reply confirming receipt by the imaging service of transmitted image files as well as other suitable reply files. Such reply files may comprise, for example, copies of the user transmitted image files, copies of previously transmitted image files, as well as one or more of the foregoing files which have been processed, converted, or otherwise adjusted by the imaging service. For example, such files may be converted to different file formats, resolutions, sizes, etc. In keeping with the invention, the imaging service may also be provisioned in advance to include one or more of the same or different sender addresses for forwarding an automated reply message as well as other suitable reply files of the type discussed above.

The alternative addresses may be used as part of the present invention for generating automated message replies, or, as set forth in co-pending application Ser. No. ______, may be used to provide a message recipient with alternative addresses for sending a reply to a sender in real time. For example, in the case of e-mail, when the recipient indicates she wishes to generate a reply to an e-mail message, the system may prompt the user to select which (one or more) of the sender's addresses (voice, video, e-mail, fax, etc.) To send the reply. Of course, if the voice or video address is selected, the recipient may be further prompted to record an audio or video message through an appropriate recording device or storage media. In such case, the reply criteria may include a selection of the type of message (fax, voice, video, text) as well as the content of the message.

As readily seen, templates may be provided as pop-up menus or otherwise by the system to allow the user to fill in required information for use as part of the user profile or otherwise including replies. This information may include, as indicated above, dates when the user has left for vacation, the date the user will return from vacation, or any other suitable information which the user desires to provide to a sender in an automated reply.

Alternatively, users may generate and store as part of the user profile, or otherwise, sender-specific and/or time/date specific reply messages to be sent based on predetermined criteria. Any suitable criteria may be used and provisioned within the system including, by way of example, but not limitation, the date, time, day of week, number of e-mail messages sent to a selected recipient, number of e-mail messages sent to the recipient in a specified time, number of e-mail messages sent to the recipient by the sender, the date the recipient last received or retrieved e-mail, the time the recipient last received or retrieved e-mail, the date the recipient last received e-mail from the sender, and the date the recipient last sent e-mail to a sender or the selected sender. Based on the user's selections provisioned within the system, one or more replies will be automatically generated in one or more mediums.

In keeping with the invention, each user's profile further includes one or more reply files to be sent in response to a received message. As in the case of the reply messages, the reply files may be generated in response to messages from one or more or all senders. Like the reply messages, the reply files may also be stored in a suitable look up table or database within the server or provisioned in communication with the server. A user may select from any number of standard reply files such as, for example, a news update, news letter, brochure, advertisement, still image, audio clip, video clip, electronic business card, annual report, Internet link, etc. Alternatively, a reply file may be selected based on suitable predetermined criteria. For example, new or unrecognized e-mail authors may be sent a firm brochure. Still further, e-mail messages received at selected times such as nights or weekends may be sent targeted advertisements regarding time sensitive sales or events. Still further, e-mail messages received from specific geographic locations may be sent geographically relevant files. Yet still further, to the extent an e-mail address may be correlated with specific demographic information, additional targeted advertisements may be forwarded believed to be most relevant to the author's hobbies or interests.

In operation, the automated method and system of the present invention will work as follows. A sender will generate a message (e-mail, fax, voice, video, etc.) at a sending computer or electronic device 12 for receipt and storage at a message server 16 for retrieval by a recipient at a computer or other electronic device 14. The message will include the recipient's specific address and the sender's address or addresses. As indicated above, the sender addresses may also be provisioned in advance by the sender or recipient. On receipt of the message at the message server 16, the message server or other electronic equipment in communication therewith, will associate the message with a specific recipient and cross reference the recipient's user profile, and in particular, both the user's reply message profile and reply file profile, to determine what, if any, reply message or messages and attached files should be generated and the corresponding address or addresses where the reply messages and reply files should be sent. In the case where a standard reply has been selected for an after-hours message, the sender will immediately receive a reply generated by the server indicating that the recipient has received the message but will not retrieve it or respond to it until the next business day. The reply message will include a standard reply file such as, for example, an electronic business card, an image file, a text file (e.g. news letter), brochure, etc. In this manner, the message sender is provided with two very important pieces of information. First, the message sender is advised that the recipient has in fact received the sender's message. Secondly, the sender is advised that the recipient has not retrieved it but will do so on the next business day. The recipient may also use the event as an opportunity for cross selling and/or to provide additional information to the message sender regarding the recipient and/or the recipient's business. As readily seen, in cases where the recipient will have an extended absence such as by vacation or otherwise, the immediate reply generated for receipt by the sender will provide useful information to enable the sender to take any other action which may be required once the sender is advised that the recipient will neither retrieve nor reply to the message for some time. For example, the sender of the message may direct the message elsewhere.

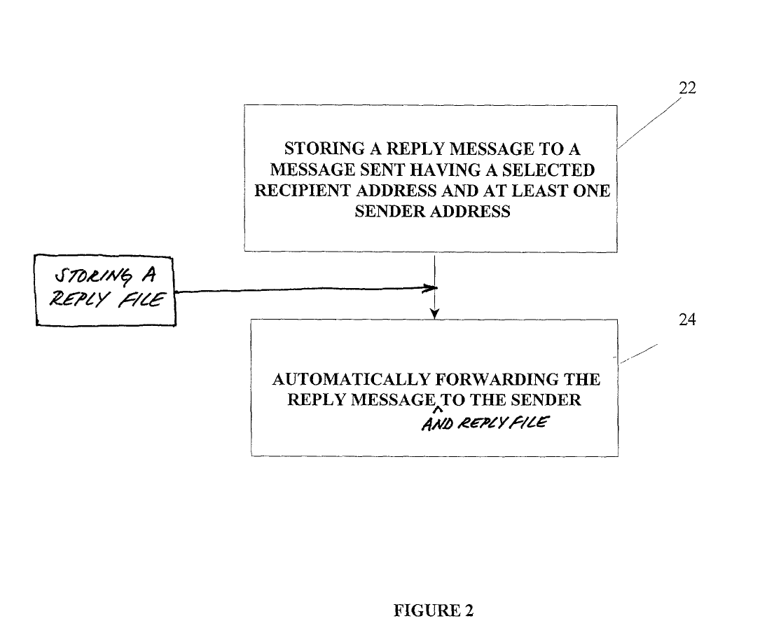

Referring now to FIG. 2 of the drawings, the method steps of the invention are explained in further detail. As indicated above, the method is adapted for use with a communications system including at least one message server operative to receive and store messages/image files for retrieval. Each message/file includes a sender address and a recipient address. The automated method for generating a reply message and/or reply file to a sender includes storing 22 a reply message to a message sent having a selected recipient address and at least one sender address. The method further includes storing 23 a reply file to be sent to the sender, preferably, but not necessarily, by attachment to the message reply. Finally, the method includes automatically forwarding 24 the reply message and reply file to the sender. The reply message and reply file may, of course, be forwarded to the sender address identified in the message or to different address such as, for example, an alternative sender address provisioned in the message server. The automatic reply message and reply file may also be forwarded to the sender through different mediums from one another as well as the original message. For example, a reply message to an e-mail message may be generated as a fax image and forwarded to a facsimile address and a corresponding reply file may be generated as an audio clip and sent to the sender's voice mail. Again, in keeping with the invention, the reply message generated may be selected in accordance with predetermined criteria including, but not limited to, that identified above such as day, date, time, etc. Still further, the reply message and reply file may be sent to different addresses through the same or different mediums.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. For use with a communications system including at least one message server operative to receive and store messages for retrieval, each message having a sender address and a recipient address, an automated method to reply to a sender, comprising:
storing a reply message to a message sent having a selected recipient address and at least one sender address;
storing a reply file for the reply message; and
automatically forwarding the reply message and reply file to the sender.

2. A method as in claim 1, wherein the reply message and reply file are forwarded to the sender at the at least one sender address.

3. A method as in claim 1, wherein the reply message and reply file are forwarded to the sender at an address different from that identified in the message.

4. A method as in claim 1, wherein the reply file is attached to the reply message.

5. A method as in claim 1, wherein the reply file is a text file.

6. A method as in claim 1, wherein the reply file is an image file.

7. A method as in claim 6, wherein the image file is a digital still image.

8. A method as in claim 1, wherein the reply file is a video clip.

9. A method as in claim 1, wherein the reply file is an audio clip.

10. A method as in claim 1, wherein the reply file comprises an Internet link.

11. For use with a communications system including at least one message server operative to receive and store messages for retrieval, each message having a sender address and a recipient address, an automated method to reply to a sender, comprising:
storing a reply message to a message sent having a selected recipient address and at least one sender address;
storing a reply Internet link for attachment to the reply message; and
automatically forwarding the reply message and reply Internet link to the sender.

12. For use with a communications system including at least one e-mail server in communication with a plurality of computers, each of the computers operative to send and receive e-mail messages via the at least one e-mail server, each e-mail message having a sender address and a recipient address, an automated method for an e-mail recipient to reply to e-mail messages from e-mail senders without retrieving the e-mail messages, comprising:
storing a reply message from the e-mail recipient for an e-mail message sent having the recipient's address and a selected sender address;
storing a reply file for attachment to the reply message; and
automatically forwarding the reply message and reply file to the sender address.

13. A method as in claim 12, further comprising storing the reply message and reply file at the at least one e- mail server.

14. For use with a communications system including at least one e-mail server in communication with a plurality of computers, each of the computers operative to send and receive e-mail messages via the at least one e-mail server, each e-mail message having a sender address and a recipient address, an automated method for an e-mail recipient to reply to e-mail messages from e-mail senders without retrieving the e-mail messages, comprising:
for each of a plurality of selected sender addresses, storing at the e-mail server: (a) at least one corresponding reply message from the e-mail recipient; and (b) at least one corresponding reply file from the e-mail recipient, for e-mail messages sent having the recipient's address and the selected sender address; and
on receipt at the at least one e-mail server of an e-mail message having the recipient's address and one of the selected sender addresses, automatically forwarding: (a)the at least one stored reply message; and (b) the at least one stored reply file, to the sender at the selected sender address.

15. A method as in claim 14, further comprising:
storing at the e-mail server a plurality of corresponding reply messages;
storing at the e-mail server a plurality of corresponding reply files;
selecting a reply message in accordance with a first predetermined criteria; and
selecting a reply file in accordance with a second predetermined criteria.

16. A method as in claim 15, wherein the first or second predetermined criteria is selected from the group consisting of date, time, day of week, number of e-mail messages sent to the recipient, number of e-mail messages sent to the recipient by the sender, the date the recipient last retrieved e-mail, the time the recipient last retrieved e-mail, the date the recipient last received e-mail from the sender, and the date the recipient last sent e-mail to the sender.

17. An e-mail system, comprising:
at least one e-mail server in communication with a plurality of computers, each of the computers operative to send and receive e-mail messages via the at least one e-mail server, each e-mail message having a sender address and a recipient address, the e-mail server operative to:
(a) store a reply message from the e-mail recipient to an e-mail message sent having the recipient's address and a selected sender address;
(b) store a reply file for attachment to the reply message; and
(c) automatically forward the reply message and reply file to the sender address.

18. An e-mail system, comprising:
at least one e-mail server in communication with a plurality of computers, each of the computers operative to send and receive e-mail messages via the at least one e-mail server, each e-mail message having a sender address and a recipient address, the e-mail server operative to:
(a) for each of a plurality of sender addresses, storing at least one reply message from the e-mail recipient for an e-mail message sent having the recipient's address and the selected sender address;
(b) store at least one reply file for attachment to the at least one reply message;
(c) on receipt at the at least one e-mail server of an e-mail message having the recipient's address and one of the selected sender addresses, automatically forward the at least one stored reply message and the at least one stored reply file to the selected sender address.

19. An e-mail system as in claim 18, wherein the e-mail server is further operative to store a plurality or reply messages and a plurality of reply files for each selected sender address and select a reply message and a reply file in accordance with predetermined criteria.

20. An e-mail system as in claim 19, wherein the predetermined criteria is selected from the group consisting of date, time, day of week, the number of e-mail messages sent to the recipient, the number of e-mail messages sent to the recipient by the sender, the date the recipient last retrieved e-mail, the date the recipient last received e-mail from the sender, and the date the recipient last sent e-mail to the sender.

21. For use with a communications system including at least one message server operative to receive and store image files for retrieval from a digital camera, each image file having a sender address and a recipient address, an automated method to reply to a sender, comprising:
storing a reply message to an image file sent having a selected recipient address and at least one sender address; and
automatically forwarding the reply message to the sender.

22. A method as in claim 21, wherein the reply message is forwarded to the sender at the at least one sender address.

23. A method as in claim 21, wherein the reply message is forwarded to the sender at an address different from that identified in the image file.

24. A method as in claim 21, wherein the reply message is forwarded to the sender at an address different from that identified in the image file.

25. For use with a communications system including at least one message server operative to receive and store image files for retrieval from a digital camera, each image file having a sender address and a recipient address, an automated method to reply to a sender, comprising:
storing a reply message to an image file sent having a selected recipient address and at least one sender address;
storing a reply file for the reply message; and
automatically forwarding the reply message and reply file to the sender.

26. A method as in claim 25, wherein the reply message and reply file are forwarded to the sender at the at least one sender address.

27. A method as in claim 25, wherein the reply message and reply file are forwarded to the sender at an address different from that identified in the image file.

28. A method as in claim 25, wherein the reply message and reply file are forwarded to the sender at an address different from that identified in the image file.

29. A method as in claim 25, wherein the reply file comprises a digital image.
